(19) United States
(12) Patent Application Publication
(10) Pub. No.: US 2002/0061403 A1
(43) Pub. Date: May 23, 2002

(54) Method of gilding quartz or high aluminum-oxide-containing tube durable under high temperature and high voltage, and gilded quartz or high aluminum-oxide-containing tube applied in ozone generator

(76) Inventors: Huei-Tarng Liou, Taipei (TW); Kuang-Lang Huang, Taipei (TW)

Correspondence Address: KENYON & KENYON, One Broadway, New York, NY, 10004, US

(21) Appl. No.: 09/782,072

(22) Filed: Feb. 12, 2001

(30) Foreign Application Priority Data
Oct. 24, 2000 (CN) 89122309

(51) Int. Cl. B05D 3/02; B05D 5/12; B32B 1/08

(52) U.S. Cl. 428/434; 427/314; 427/383.5; 428/34.4

(57) ABSTRACT

The present invention relates to a method for metal coating on a tube, particularly a tube for ozone generators which have been widely used for commercial and industrial purposes. Quartz or high aluminum-oxide-containing is a preferred material for the tube for an ozone generator. According to the present method, the tube is coated with a film of gold by putting the tube in a stove wherein the temperature and baking time is controlled. The present method for coating improves the durability of tubes operated at high temperature brought forth by micro-discharge, and thus extends the service life of the tube as used in an ozone generator.

### FIELD OF INVENTION

The present invention relates to a method of gilding quartz or high aluminum-oxide-containing tube and ozone generating tubes produced by this method.

### BACKGROUND

Ozone generators used for commercial and industrial purposes generally utilize micro-discharge method for producing ozone. The ozone produced by this method is governed by Manley's formula:

$$P = 4 {fC}_{v} {U}_{d} [ {U}_{m} - {U}_{d} ( 1 + \frac{{C}_{a}}{{C}_{v}} ) ] ,$$

wherein

P is the energy stored between dielectric materials;

f is the frequency of power supply;

Cᵥ is the dielectric coefficient of capacitor;

U_{d} is the magnitude of discharged voltage;

Uₘ is the applied voltage between two electrodes; and

Cₐ is the dielectric coefficient of the space between two electrodes.

According to the foregoing formula, the energy stored between the dielectric materials is proportional to the frequency of power supply. In operation, the frequency of power supply is raised in order to increase the throughput or the concentration of ozone.

FIG. 1 is a schematic diagram showing the generation of ozone using micro-discharge method. In this diagram, there is a pair of electrodes 2, and one of which is coated with dielectric 4. The pair of electrodes 2 are connected to a power supply 6. When gas carrying oxygen flows through the high voltage discharge zone as indicated by the arrow in the figure, the oxygen would be discharged to generate ozone.

The dielectric used in micro-discharge process must withstand the impact caused by electrons in high voltage and must be anti-oxidizing, and more importantly, can endure high temperature resulted from micro-discharged energy generated at high frequency and high voltage.

Ozone generators utilizing micro-discharge at high frequency and high voltage generally comprise an important element that is the ozone generating tube. The ozone generating tubes are normally made of a kind of material named “pyrex.” The internal surface of the tube is provided with silicon steel plate or stainless steel plate to serve as a conductor. However, such structure may not remain in good contact with the dielectric and thus is not well electrically conductive. For this reason, a great amount of heat may be generated in some areas of the surface of the tube, and results in damage to the tube. This is why an ozone generator cannot be operated for a contented period of time. The method to overcome this problem is to coat a metal material on the surface of the tube. However, a critical point is how a tube is coated with a layer of metal, and what metal is selected as a coating material. A known and widely used method is vapor deposition. However, the tubes produced by this method cannot endure long enough since the coating so formed on the tube cannot resist the impact of the electrons under high frequency and high voltage. In addition, the heat generated on the tube also causes damages to the coating.

The object of the present invention is to select preferred materials for an ozone generating tube and coating metal, and to improve the method for coating the tube with the selected material so that the tube as well as the coating metal may resist high temperature, and the service life of an ozone generator can thus be extended when such a coated tube is applied in the ozone generator.

### SUMMARY OF INVENTION

The present invention is directed to a method for coating an ozone generating tube used in an ozone generator which employs micro-discharge to produce ozone, and is directed to overcome the shortcomings of ozone generating tubes in failing to withstand the high-temperature generated therein.

In the present invention, tubes made of quartz or high aluminum-oxide-containing materials are chosen to serve as ozone generating tubes, and gold is selected as the coating metal for the reasons that quartz or high aluminum-oxide-containing materials can endure a temperature above 1400° C. and gold is a good conductor. The method includes stove baking for forming a gold coating on the surface of the tube. The coating made by this method adheres well on the surface such that it will not easily scale off under the impact of electrons at high frequency and high voltage. The high frequency is defined at the range from 15 KHz to 40 KHz; and the high voltage is defined at a peak-to-peak value from 10 KV to 18 KV.

The characteristics of the present can be summarized as follows: (1) quartz tubes or high aluminum-oxide-containing tubes are used as dielectric, and are able to endure temperature above 1400° C.; (2) gold is a good conductor, stable in property and structure, able to resist the impact of electrons under high voltage, and has the properties of withstanding high temperature and anti-oxidization; (3) using stove baking method, which is able to form a gold film of 0.06 μm in thickness on the surface of quartz or high aluminum-oxide-containing tubes, and the gold film adheres on the surface more securely than that formed by vapor deposition, and is effective to withstand high temperature and the impact of electrons caused by high voltage, and will not scale off from the surface; (4) the manufacturing process of the ozone generating tubes is simpler.

### BRIEF DESCRIPTION OF DRAWINGS

FIG. 1 is a schematic diagram showing a theoretic process of micro-discharge for producing ozone; and

FIG. 2 is a schematic diagram showing an ozone generating tube used in an ozone generator employing micro-discharge method for producing ozone.

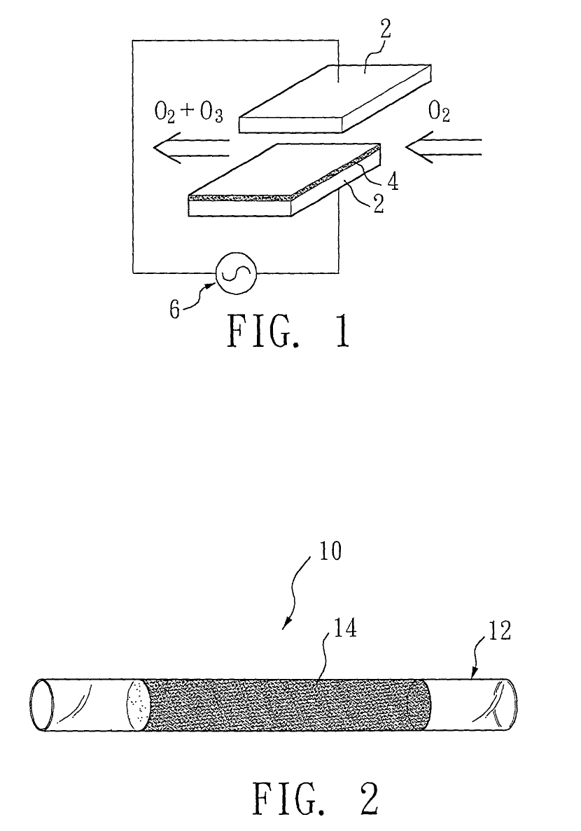

### DETAILED DESCRIPTION OF PREFERRED EMBODIMENT

FIG. 2 is a schematic diagram showing an ozone generating tube 10, wherein the tube body 12 is made of materials, such as quartz or high aluminum-oxide-containing materials, which has the property of enduring temperature above 1400° C. The surface of the tube body 12 is coated with a gold film 14 by a stove-baking method as is described hereinafter.

The method of coating gold film 14 on the surface of tube body 12 comprises the steps of: preparing the material to be coated; cleaning the tube body 12 and subsequently drying the same; coating the material on the surface of the tube body 12; spreading the coating material and drying the same; placing the coated tube in a stove and baking the same for a determined period of time, and subsequently retrieving the tube from the stove and placing it under room temperature.

In applying the present method, it is very important to keep the working environment clean, and keep any impurities, such as dust, suspended particles, from attaching on the surface of tube body 12. The impurities may cause serious damages to the subsequent processes of gold coating.

The preferred coating material used in the method is a gold chloride (AuCl₃) solution of 10˜11% concentration. The solution can be diluted by a sulfur-containing volatile oil, which is widely available in the market.

The quartz or high aluminum-oxide-containing tube will go through a cleansing process to have the residual grease or impurities removed from the surface thereof. A subsequent drying process is preferred before the tube is ready for being applied with coating-material. The AuCl₃ solution is uniformly smeared on the surface 12 of the quartz or high aluminum-oxide-containing tube. After the gold film is formed, the tube is kept at room temperature for thirty minutes and then put into a stove for baking. Before put into the stove, the tube has to be carefully inspected whether the film formed thereon is uniform. The temperature in the stove is maintained between 780˜880° C., and the tube is baked in the stove for 10 to 14 hours. The preferred baking time depends on the diameter of the tube and the dimension of the stove. As baking time is over, and the temperature in the stove is going down to below 110° C., or preferably below 100° C., the tube is taken out of the stove and kept at room temperature for cooling. The thickness of the gold film should be greater than 0.06 μm to be a qualified product. If the thickness of the film is not sufficient, the operating life of the tube will be significantly reduced. The thickness that the solution smeared on the surface of the tube is critical in order to assure a sufficient thickness of the film formed on the tube.

While the representative embodiment and details have been shown for the purpose of illustrating the invention, it will be apparent to those skilled in this art that various changes and modifications may be made therein without departing from the spirit or scope of the invention.

### List of Reference Numerals

2 electrode

4 dielectric

6 alternative power supply

10 ozone generating tube

12 tube body

14 gold film

What is claimed is:

1. A method of gilding quartz or high aluminum-oxide-containing tube, comprising:
preparing coating material which contains gold;
cleansing the quartz or high aluminum-oxide-containing tube;
drying the quartz or high aluminum-oxide-containing tube;
smearing the prepared the coating material on the quartz or high aluminum-oxide-containing tube to form a film thereon;
drying the quartz or high aluminum-oxide-containing tube;
inspecting the dried quartz or high aluminum-oxide-containing tube to see if the film is formed uniformly and free of defects;
putting the dried quartz or high aluminum-oxide-containing tube into a stove, which is maintained at the temperature between 780 to 880° C., to bake for 10 to 14 hours; and
retrieving the tube after the temperature in the stove is below 110° C., and putting the tube under room temperature.

2. The method according to claim 1, wherein the coating material is prepared so that it contains 1.0˜1.1% concentration of AuCl₃.

3. The method according to claim 2, wherein quartz or high aluminum-oxide-containing tube is kept under room temperature for thirty minutes after the coating material is smeared thereon.

4. The method according to claim 3, wherein the baking time is 12 hours.

5. The method according to claim 4, wherein the quartz or high aluminum-oxide-containing tube is taken out of the stove when the stove temperature drops below 100° C., and is then cooled under room temperature.

6. A gilded quartz or high aluminum-oxide-containing tube used in ozone generator comprises a gold film formed through the method according to claim 1.

7. A gilded quartz or high aluminum-oxide-containing tube used in ozone generator comprises a gold film formed through the method according to claim 5.

8. The gilded quartz or high aluminum-oxide-containing tube according to claim 7, wherein the thickness of gold film is at least 0.06 μm.
